(19) United States
(12) Patent Application Publication
(10) Pub. No.: US 2026/0149000 A1
(43) Pub. Date: May 28, 2026

(54) ELECTRODE AND ELECTRODE ASSEMBLY INCLUDING SAME

(71) Applicant: SAMSUNG SDI CO., LTD., Yongin-Si Gyeonggi-do (KR)

(72) Inventor: Junho BYEON, Yongin-Si (KR)

(21) Appl. No.: 19/177,751

(22) Filed: Apr. 14, 2025

(30) Foreign Application Priority Data
Sep. 11, 2024 (KR) 10-2024-0123893

(51) Int. Cl. H01M 4/66; H01M 50/54

(52) U.S. Cl. CPC H01M 4/667; H01M 4/662; H01M 4/668; H01M 50/54

(57) ABSTRACT

An electrode includes an insulating film layer including an insulating material, a first metal layer on one surface of the insulating film layer, a second metal layer on another surface of the insulating film layer, a first mixture layer on the first metal layer, a second mixture layer on the second metal layer, and a conductive tape attached to the first metal layer and the second metal layer and configured to electrically connect the first metal layer to the second metal layer.

### CROSS-REFERENCE TO RELATED APPLICATION

The present application claims priority to and the benefit of Korean Application No. 10-2024-0123893, filed on Sep. 11, 2024, in the Korean Intellectual Property Office, the entire disclosure of which is incorporated herein by reference.

### BACKGROUND

### 1. Field

Aspects of embodiments of the present disclosure relate to an electrode and an electrode assembly including the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Various research and development efforts are being conducted to reduce the weight of secondary batteries, reduce costs, improve safety, and increase energy density. In the past, electrode substrates were made of metal and were very heavy. Recently, composite substrates with thin metal layers formed on opposite surfaces of an insulating layer made of a light material such as polyethylene terephthalate (PET) have been used. However, because the composite substrate is made by welding a separate metal substrate to a thin metal layer in order to conduct current between the metal layers formed on opposite surfaces of the insulating layer, problems such as quality deterioration due to the welding process may occur.

The above information disclosed in this Background section is for enhancement of understanding of the background of the present disclosure, and therefore, it may contain information that does not constitute related (or prior) art.

### SUMMARY

Aspects of embodiments of the present disclosure provide an electrode for solving the above-described problems and an electrode assembly including the same.

These and other aspects and features of the present disclosure will be described in or will be apparent from the following description of embodiments of the present disclosure.

According to one or more embodiments of the present disclosure, an electrode may include an insulating film layer including an insulating material, a first metal layer on one surface of the insulating film layer, a second metal layer on another surface of the insulating film layer, a first mixture layer on the first metal layer, a second mixture layer on the second metal layer, and a conductive tape attached to the first metal layer and the second metal layer and configured to electrically connect the first metal layer to the second metal layer.

In some embodiments, the conductive tape may include a first attachment portion attached to the first metal layer, a second attachment portion attached to the second metal layer, and a bent portion bent between the first attachment portion and the second attachment portion.

In some embodiments, the bent portion may be attached to ends of the first metal layer, the insulating film layer, and the second metal layer.

In some embodiments, the bent portion may be spaced apart from ends of the first metal layer, the insulating film layer, and the second metal layer.

In some embodiments, the conductive tape may include a same material as a material of at least one of the first metal layer or the second metal layer.

In some embodiments, the conductive tape may include at least one of aluminum, an aluminum alloy, copper, a copper alloy, nickel, or a nickel alloy.

In some embodiments, a thickness of the conductive tape may be in a range from approximately 1 μm to approximately 6 μm.

In some embodiments, the electrode may further include a conductive paste and a binder between the conductive tape and at least one of the first metal layer and the second metal layer.

In some embodiments, the conductive paste may be on at least one of the first metal layer or the second metal layer, and the binder may be on one surface of the conductive tape.

In some embodiments, the conductive paste may be on one surface of the conductive tape, and the binder may be on the conductive paste.

In some embodiments, the conductive paste may be on one surface of the conductive tape, the binder may be on the conductive paste, and the conductive paste may be on at least one of the first metal layer or the second metal layer.

In some embodiments, the conductive paste may be a same material as a material of the conductive tape.

In some embodiments, the conductive paste may include a same material as a material of at least one of the first metal layer or the second metal layer.

In some embodiments, the conductive tape may include a first conductive tape attached to the first metal layer, and a second conductive tape attached to the second metal layer and to the first conductive tape.

In some embodiments, one end of the first conductive tape may be attached to the first metal layer, one end of the second conductive tape may be attached to the second metal layer, and another end of the first conductive tape and another end of the second conductive tape may be attached to each other.

In some embodiments, the electrode may further include a conductive paste and a binder between the first metal layer and the first conductive tape and between the second metal layer and the first conductive tape.

In some embodiments, the conductive paste and the binder may be on one surface of the first conductive tape and one surface of the second conductive tape.

According to one or more embodiments of the present disclosure, an electrode assembly may include a first electrode including at least a first electrode tab, a second electrode including at least a second electrode tab, and a separator between the first electrode and the second electrode. At least one of the first electrode or the second electrode may include an insulating film layer including an insulating material, a first metal layer on one surface of the insulating film layer, a second metal layer on another surface of the insulating film layer, a first mixture layer on the first metal layer, a second mixture layer on the second metal layer, and a conductive tape attached to the first metal layer and the second metal layer and electrically connecting the first metal layer and the second metal layer.

In some embodiments, both the first electrode and the second electrode may include the conductive tape.

In some embodiments, the first electrode tab includes two or more stacked first electrode tabs, the second electrode tab includes two or more stacked second electrode tabs, and at least one of the stacked first electrode tabs or the stacked second electrode tabs includes two or more stacked conductive tapes attached and connected to each other.

According to some embodiments of the present disclosure, the conductive tape may be attached so that the metal layers formed on opposite surfaces of the insulating film layer constituting the electrode of the secondary battery are electrically connected to each other to form the current path.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an electrode according to some embodiments of the present disclosure.

FIG. 2 illustrates an electrode to which a conductive tape is attached according to some embodiments of the present disclosure.

FIG. 3 illustrates an electrode including a conductive paste and a binder according to some embodiments of the present disclosure.

FIG. 4 illustrates an electrode including a conductive paste and a binder to which a conductive tape is attached according to some embodiments of the present disclosure.

FIG. 5 illustrates aspects of manufacturing an electrode according to some embodiments of the present disclosure.

FIGS. 6 to 8 illustrate a conductive paste and a binder applied to an electrode according to some embodiments of the present disclosure.

FIG. 9 illustrates a conductive tape attached to an electrode according to some embodiments of the present disclosure.

FIG. 10 illustrates a conductive paste and a binder provided in the embodiment of FIG. 9.

FIG. 11 illustrates aspects of manufacturing an electrode according to some embodiments of the present disclosure.

FIG. 12 illustrates aspects of manufacturing an electrode assembly according to some embodiments of the present disclosure.

FIG. 13 illustrates an exploded perspective view showing a secondary battery according to some embodiments of the present disclosure.

FIG. 14 is a flowchart showing aspects of a method for manufacturing an electrode according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

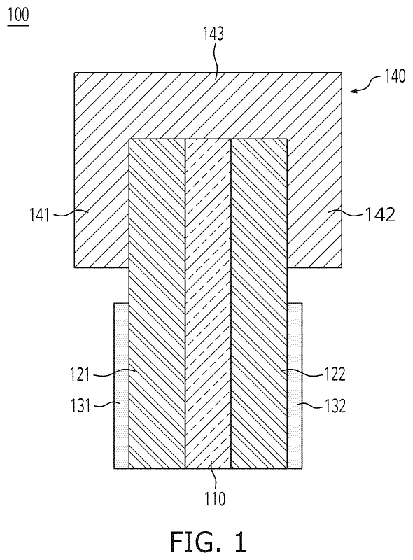

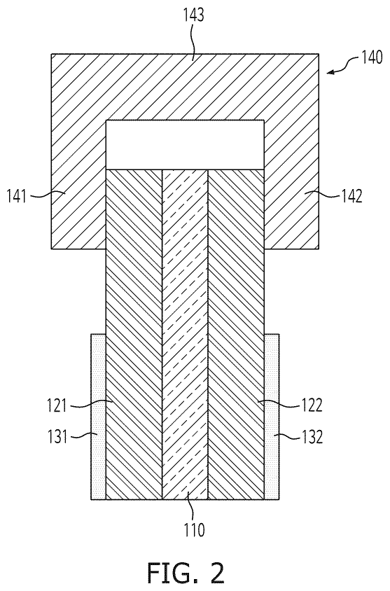

FIGS. 1 and 2 illustrate an electrode according to some embodiments of the present disclosure to which a conductive tape is attached.

Referring to FIGS. 1 and 2, an electrode 100 according to some embodiments of the present disclosure may include an insulating film layer 110 made of (or including) an insulating material, a first metal layer 121 on one surface of the insulating film layer 110, a second metal layer 122 on the other surface (e.g., the opposite surface) of the insulating film layer 110, a first mixture layer 131 on the first metal layer 121, a second mixture layer 132 on the second metal layer 122, and a conductive tape 140 attached to both the first metal layer 121 and the second metal layer 122 and electrically connecting the first metal layer 121 and the second metal layer 122 to each other. The first mixture layer 131 may be in a portion of the first metal layer 121 and the second metal layer 122 may be in a portion of the second metal layer 122. The conductive tape 140 may be attached to a portion of the first metal layer 121 and the second metal layer 122 where the first mixture layer 131 and the second mixture layer 132, respectively, are not provided.

The insulating film layer 110 may be made of a polymer material. For example, the insulating film layer 110 may be made of (or include) polyethylene terephthalate (PET) resin. In some embodiments, the material of the insulating film layer 110 is not limited thereto and may be made of (or include) polyester resin such as polytrimethylene terephthalate (PTT), polybutylene terephthalate (PBT), or polyethylene naphthalate (PEN).

Each of the first metal layer 121 and the second metal layer 122 may be made of (or include) a metal material such as copper, a copper alloy, nickel, or a nickel alloy on the insulating film layer 110, or may be made of (or include) a metal material such as aluminum or an aluminum alloy thereon. The first metal layer 121 and the second metal layer 122 may be made of (or include) the same metal material and may function as a positive electrode or a negative electrode.

In some embodiments, the first metal layer 121 and the second metal layer 122 are made of (or include) a metal material such as copper, a copper alloy, nickel, or a nickel alloy, and the first mixture layer 131 and the second mixture layer 132 may be configured to include a binder and a conductive material in a negative electrode active material. The negative active material may include, for example, graphite.

In some embodiments, the first metal layer 121 and the second metal layer 122 are made of (or include) a metal material such as aluminum or an aluminum alloy, and the first mixture layer 131 and the second mixture layer 132 may be configured to include a binder and a conductive material in a positive electrode active material. The positive electrode active material may include, for example, a transition metal oxide.

The conductive tape 140 may be made of the same material as at least one of the first metal layer 121 or the second metal layer 122. In some embodiments, the first metal layer 121 and the second metal layer 122 are made of (or include) copper, a copper alloy, nickel, or a nickel alloy, and the conductive tape 140 may be made of (or include) copper, a copper alloy, nickel, or a nickel alloy. In some embodiments, the first metal layer 121 and the second metal layer 122 are made of (or include) aluminum or an aluminum alloy, and the conductive tape 140 may be made of (or include) aluminum or an aluminum alloy. In some embodiments, the material of the conductive tape 140 is not limited thereto, and any material with sufficient electrical conductivity may be utilized.

The conductive tape 140 may have an adhesive layer on one surface so as to be attached to the first metal layer 121 and the second metal layer 122. The adhesive layer may be formed by applying, coating, or attaching an adhesive material. As an example, the adhesive layer may be made of (or include) a material such as acrylic that reacts with an electrolyte within the operating temperature range of the secondary battery and has adhesive properties.

The conductive tape 140 may be a thin film having a thickness of approximately 1 μm to approximately 6 μm. In some embodiments, the thickness of the conductive tape 140 is not limited thereto and may vary depending on various conditions such as the thicknesses of the insulating film layer 110, the first metal layer 121, and the second metal layer 122.

As described above, as the insulating film layer 110 is made of (or includes) polymer resin, which is configured to ensure the flexibility and lightness of the electrode 100. The first metal layer 121 and the second metal layer 122 may be formed on opposite surfaces of the insulating film layer 110, and the current path may be formed by connecting the first metal layer 121 and the second metal layer 122 with the conductive tape 140. In this manner, substantially the same electrical conductivity and battery performance may be achieved compared to electrodes made of a single metal material.

The conductive tape 140 may have a length substantially corresponding to the length of the insulating film layer 110. In some embodiments, the width of the conductive tape 140 may be sufficient such that the conductive tape 140 may be attached to the first metal layer 121 and the second metal layer 122 while surrounding the first metal layer 121, the insulating film layer 110, and the second metal layer 122 stacked together.

In some embodiments, the conductive tape 140 may include a first attachment portion 141 attached to the first metal layer 121, a second attachment portion 142 attached to the second metal layer 122, and a bent portion 143 bent between the first attachment portion 141 and the second attachment portion 142. The first attachment portion 141, the bent portion 143, and the second attachment portion 142 may be portions of the conductive tape 140 in the width direction.

With this configuration, the first attachment portion 141 of the conductive tape 140 may be attached to the first metal layer 121, and then the second attachment portion 142 of the conductive tape 140 may be attached to the second metal layer 122. In some embodiments, the second attachment portion 142 of the conductive tape 140 may be attached to the second metal layer 122 first, and then the second attachment portion 142 of the conductive tape 140 may be attached to the first metal layer 121.

The bent portion 143 may be attached to the ends of the first metal layer 121, the insulating film layer 110, and the second metal layer 122, as shown in FIG. 1. In some embodiments, the bent portion 143 may be spaced apart (e.g., by a gap) from the ends of the first metal layer 121, the insulating film layer 110, and the second metal layer 122, as shown in FIG. 2. Because the conductive tape 140 may perform a function of an electrode tab, the length of the electrode tab may be adjusted by adjusting the length of the bent portion 143 as desired.

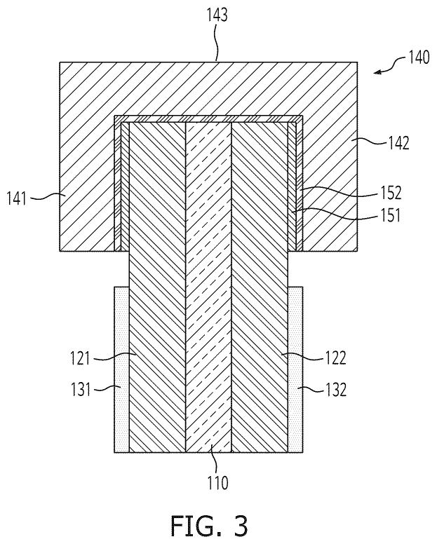

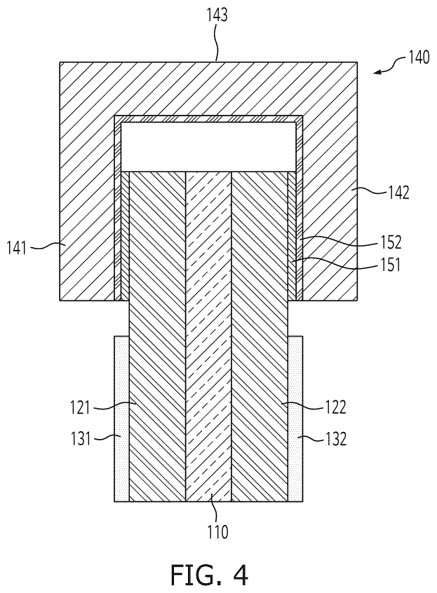

FIGS. 3 and 4 illustrate an electrode including a conductive paste and a binder to which a conductive tape is attached according to some embodiments of the present disclosure.

Referring to FIGS. 3 and 4, the electrode according to some embodiments of the present disclosure may include a conductive paste 151 and a binder 152 between the conductive tape 140 and at least one of the first metal layer 121 or the second metal layer 122. The conductive paste 151 may be configured to supplement the electrical conductivity between the conductive tape 140 and the first metal layer 121 and the second metal layer 122.

The conductive paste 151 may be made of (or include) the same material as the conductive tape 140. In some embodiments, the conductive paste 151 may be made of (or include) the same material as at least one of the first metal layer 121 or the second metal layer 122.

In some embodiments, the conductive tape 140, the first metal layer 121, and/or the second metal layer 122 is made of (or includes) copper, a copper alloy, nickel, or a nickel alloy, the conductive paste 151 may be made of (or include) copper, a copper alloy, nickel, or a nickel alloy. In some embodiments, the conductive tape 140, the first metal layer 121, and/or the second metal layer 122 is made of (or includes) aluminum or an aluminum alloy, and the conductive paste 151 may be made of (or include) aluminum or an aluminum alloy. In some embodiments, the material of the conductive paste 151 is not limited thereto, and any material with sufficient electrical conductivity may be utilized.

The binder 152 may be configured to control the viscosity of the conductive paste 151. The conductive paste 151 and the binder 152 are joined to increase the viscosity of the conductive paste 151, thereby improving the adhesive strength between the conductive tape 140 and the first metal layer 121 and the second metal layer 122. That is, the conductive paste 151 itself may have a low viscosity and may be easily applied. After the conductive paste 151 is applied, the conductive paste 151 may be joined to the binder 152 to improve adhesive strength. As for the conductive paste 151 and the binder 152, various known materials may be utilized.

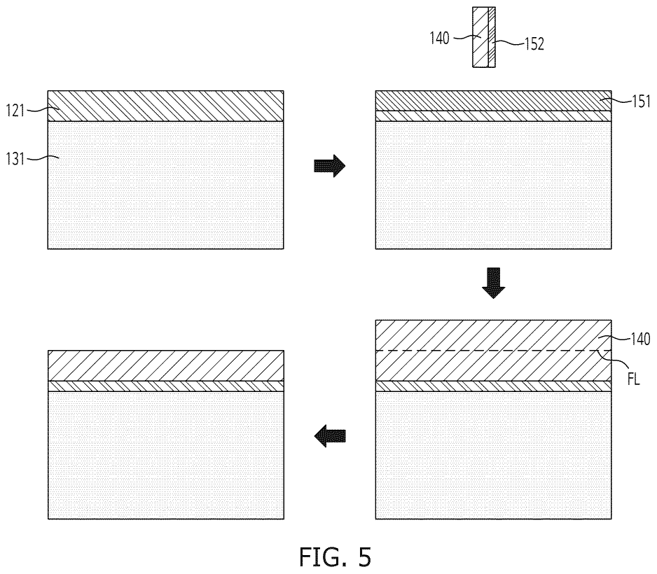

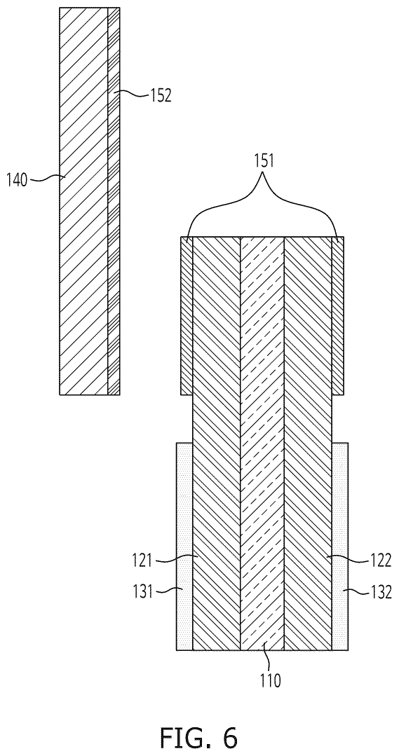

FIG. 5 illustrates an example of manufacturing an electrode according to some embodiments of the present disclosure, and FIGS. 6 to 8 illustrate an example in which a conductive paste and a binder are applied to an electrode according to some embodiments of the present disclosure.

The method of manufacturing an electrode according to some embodiments of the present disclosure may include forming a first metal layer 121 and a second metal layer 122 on opposite surfaces of an insulating film layer 110, forming a first mixture layer 131 on the first metal layer 121, and forming a second mixture layer 132 on the second metal layer 122. The electrode may be manufactured by attaching a conductive tape 140 to portions of the first metal layer 121 and the second metal layer 122 on which the first mixture layer 131 and the second mixture layer 132 are not formed. In one or more embodiments, the conductive tape 140 may be attached to the first mixture layer 131 and the second mixture layer 132 so as to be spaced apart by a certain interval (e.g., a gap). In some embodiments, the conductive tape 140 may be attached to the first mixture layer 131 and the second mixture layer 132 so as to be spaced apart by an interval of approximately 1 mm to approximately 2 mm.

In some embodiments, the electrode may further include a conductive paste 151 and a binder 152 between the conductive tape 140 and at least one of the first metal layer 121 and the second metal layer 122. Referring to FIGS. 5 and 6, the conductive paste 151 may be applied to the first metal layer 121 and the second metal layer 122, and the binder 152 may be applied to one surface of the conductive tape 140. After a part of the conductive tape 140 is attached to the first metal layer 121, the conductive tape 140 may be bent along a folding line FL so that the remainder of the conductive tape 140 may be attached to the second metal layer 122. In some embodiments, the conductive tape 140 may be attached to the second metal layer 122 first and then subsequently attached to the second metal layer 122.

In some embodiments, the conductive tape 140 to which the binder 152 is applied is attached to the first metal layer 121 and the second metal layer 122 to which the conductive paste 151 is applied, and the conductive paste 151 may chemically react with the binder 152. The adhesive strength may be improved because the viscosity of the conductive paste 151 is increased by the binder 152.

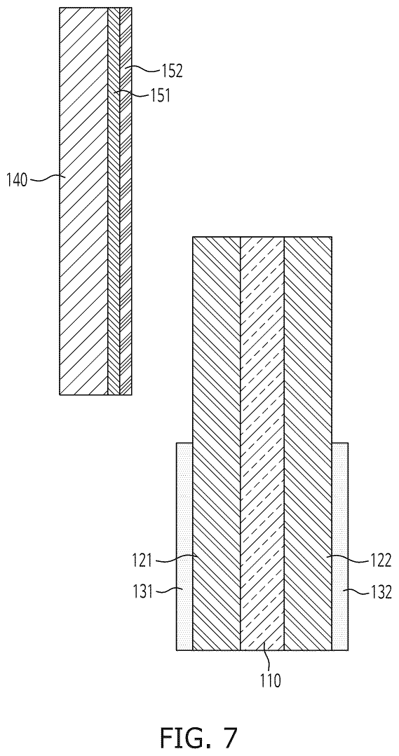

In other embodiments, referring to FIG. 7, the conductive paste 151 may be applied to one surface of the conductive tape 140, the binder 152 may be applied to the conductive paste 151, and then the conductive tape 140 may be attached to the first metal layer 121 and the second metal layer 122. In some embodiments, the conductive paste 151 may be applied after the binder 152 is applied to one surface of the conductive tape 140. The order in which the conductive paste 151 and the binder 152 are applied may be determined, for example, depending on the composition of the conductive paste 151 and the binder 152.

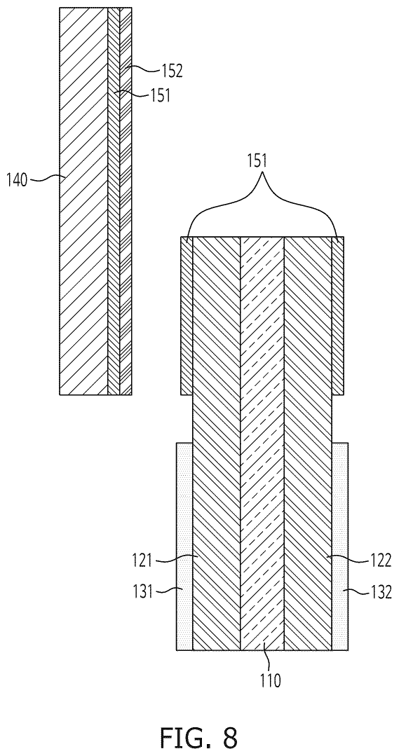

In other embodiments, referring to FIG. 8, the conductive paste 151 may be applied to one surface of the conductive tape 140, and the binder 152 may be applied to the conductive paste 151. The conductive paste 151 may be applied to at least one of the first metal layer 121 and the second metal layer 122.

In some embodiments, the conductive tape 140 to which the conductive paste 151 and the binder 152 are applied is attached to the first metal layer 121 and the second metal layer 122 to which the conductive paste 151 is applied, and the conductive paste 151 may chemically react with the binder 152. The conductive paste 151 may be applied together with the conductive tape 140, the first metal layer 121, and the second metal layer 122, thereby further improving the adhesive strength.

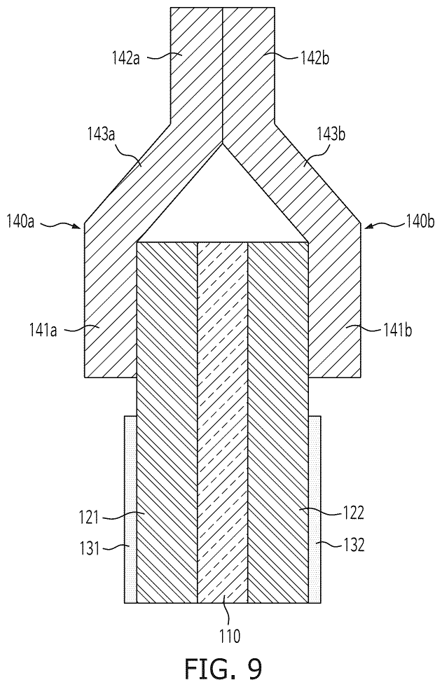

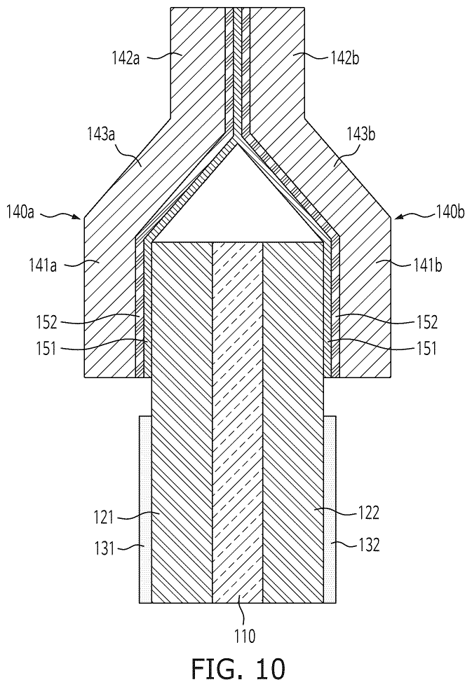

FIG. 9 illustrates another example in which a conductive tape is attached to an electrode according to some embodiments of the present disclosure, and FIG. 10 illustrates an example in which a conductive paste and a binder are utilized in the embodiment of FIG. 9.

Referring to FIG. 9, the conductive tape may include a first conductive tape 140a attached to a first metal layer 121, and a second conductive tape 140b attached to a second metal layer 122 and to the first conductive tape 140a. That is, in one or more embodiments, two conductive tapes 140a and 140b are provided, and each of the two conductive tapes 140a and 140b is attached to a metal layer 121 and 122, respectively, and then the two conductive tapes 140a and 140b are attached to each other.

In some embodiments, a first attachment portion 141a, which is one end of the first conductive tape 140a, may be attached to the first metal layer 121, and a first attachment portion 141b, which is one end of the second conductive tape 140b, may be attached to the second metal layer 122. A second attachment portion 142a, which is the other end of the first conductive tape 140a, and a second attachment portion 142b, which is the other end of the second conductive tape 140b, may be attached and electrically connected to each other. A bent portion 143a of the first conductive tape 140a and a bent portion 143b of the second conductive tape 140b may be spaced apart from the ends of the first metal layer 121, the insulating film layer 110, and the second metal layer 122 in a bent state, as shown in FIG. 9. In some embodiments, the bent portion 143a of the first conductive tape 140a and the bent portion 143b of the second conductive tape 140b may be attached to the ends of the first metal layer 121, the insulating film layer 110, and the second metal layer 122. Because the first conductive tape 140a and the second conductive tape 140b may perform the function of electrode tab, the length of the electrode tab may be adjusted by adjusting the length of the bent portion 143 as desired.

Referring to FIG. 10, the electrode according to some embodiments may further include a conductive paste 151 and a binder 152 between the first metal layer 121 and the first conductive tape 140a and between the second metal layer 122 and the first conductive tape 140a.

In some embodiments, the conductive paste 151 and the binder 152 may be applied to one surface of the first conductive tape 140a, and the conductive paste 151 and the binder 152 may be applied to one surface of the second conductive tape 140b, and then the first conductive tape 140a and the second conductive tape 140b may be attached. As shown in FIG. 10, the binder 152 may be applied to one surface of the first conductive tape 140a and the second conductive tape 140b, and then the conductive paste 151 may be applied to the binder 152. In some embodiments, the conductive paste 151 may be applied to one surface of the first conductive tape 140a and the second conductive tape 140b, and then binder 152 may be applied. The order in which the conductive paste 151 and the binder 152 are applied may be determined, for example, depending on the composition of the conductive paste 151 and the binder 152.

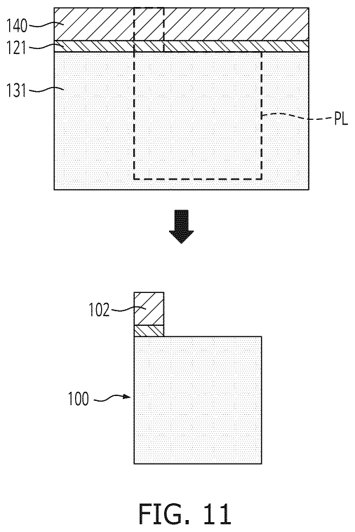

FIG. 11 illustrates an example of manufacturing an electrode according to some embodiments of the present disclosure.

The method of manufacturing an electrode according to some embodiments of the present disclosure may include forming a first metal layer 121 and a second metal layer 122 on opposite surfaces of an insulating film layer 110, forming a first mixture layer 131 on the first metal layer 121, and forming a second mixture layer 132 on the second metal layer 122. A conductive tape 140 may be attached to portions of the first metal layer 121 and the second metal layer 122 on which the first mixture layer 131 and the second mixture layer 132 are not formed by using the method described with reference to FIGS. 1 to 10. As shown in FIG. 11, a substrate to which the conductive tape 140 is attached may be punched (i.e., cut) along a punching line PL to manufacture an electrode 100 having an electrode tab 102.

The electrode 100 may function as a positive electrode or a negative electrode according to a type of metal formed in the first metal layer 121 and the second metal layer 122. The electrode tab in the electrode functioning as a positive electrode and the electrode tab in the electrode functioning as a negative electrode may be manufactured in different directions (e.g., the electrode tabs of the positive and negative electrodes may be staggered or offset from each other).

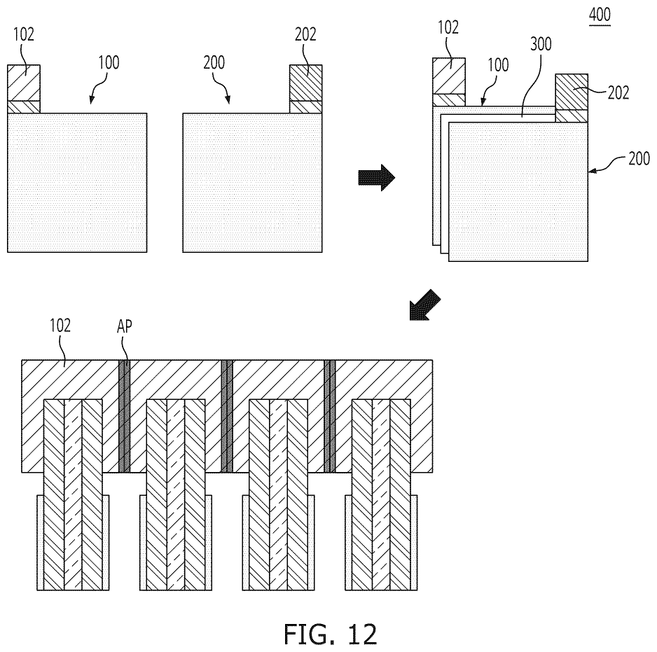

FIG. 12 illustrates an example of manufacturing an electrode assembly according to some embodiments of the present disclosure.

Referring to FIGS. 1 and 12, an electrode assembly 400 according to some embodiments of the present disclosure may include a first electrode 100, a second electrode 200, and a separator 300 between the first electrode 100 and the second electrode 200.

At least one of the first electrode 100 or the second electrode 200 may be configured by forming a mixture layer on a multilayer substrate or a mixture substrate having a metal layer formed on opposite surfaces of an insulating film layer. The first electrode 100 or the second electrode 200 may be composed of the electrodes described with reference to FIGS. 1 to 11.

Therefore, at least one of the first electrode 100 and the second electrode 200 may include an insulating film layer 110 made of (or including) an insulating material, a first metal layer 121 on one surface of the insulating film layer 110, a second metal layer 122 on the other surface (e.g., an opposite surface) of the insulating film layer 110, a first mixture layer 131 on the first metal layer 121, a second mixture layer 132 on the second metal layer 122, and a conductive tape 140 attached to the first metal layer 121 and the second metal layer 122 and electrically connecting the first metal layer 121 and the second metal layer 122 to each other.

In some embodiments, the first electrode 100 functions as a positive electrode, the first metal layer 121 and the second metal layer 122 may be made of (or include) a metal material such as aluminum or an aluminum alloy. The first mixture layer 131 and the second mixture layer 132 may be formed by including a binder and a conductive material in a positive electrode active material. The positive electrode active material may include, for example, a transition metal oxide. The conductive tape 140 may be made of (or include) a metal such as aluminum or an aluminum alloy. In some embodiments, the conductive tape 140 is not limited thereto and may be made of a metal material with excellent electrical conductivity.

In some embodiments, the first electrode 100 functions as a negative electrode, the first metal layer 121 and the second metal layer 122 may be made of (or include) a metal material such as copper, a copper alloy, nickel, or a nickel alloy. The first mixture layer 131 and the second mixture layer 132 may be formed by including a binder and a conductive material in a negative electrode active material. The negative active material may include, for example, graphite. The conductive tape 140 may be made of (or include) a metal such as copper, a copper alloy, nickel, or a nickel alloy. In some embodiments, the conductive tape 140 is not limited thereto and may be made of (or include) a metal material with sufficient electrical conductivity.

In some embodiments, the second electrode 200 is configured to function as a positive electrode or a negative electrode, and the second electrode 200 may also be configured in the same manner as the first electrode 100. In some embodiments, the first electrode 100 is configured to function as a positive electrode, the second electrode 200 is configured to function as a negative electrode. In some embodiments, the first electrode 100 is configured to function as a negative electrode, and the second electrode 200 is configured to function as a positive electrode. As illustrated in FIG. 12, the direction in which a first electrode tab 102 of the first electrode 100 is formed may be different from the direction in which a second electrode tab 202 of the second electrode 200 is formed. Because the shape and bonding state of the conductive tape 140 are the same as those described with reference to FIGS. 1 to 10, a detailed description thereof is omitted.

The first electrode tab 102 of the first electrode 100 and the second electrode tab 202 of the second electrode 200 may include a conductive tape 140. That is, the first electrode tab 102 and the second electrode tab 202 may be formed by cutting a portion of the conductive tape 140 attached to the substrate, as illustrated in FIG. 11.

The electrode assembly 400 may be manufactured by alternately stacking a plurality of first electrodes 100, separators 300, and second electrodes 200. The first electrode tabs 102 of the first electrodes 100 may be formed in the same direction and may be stacked to face each other (e.g., the electrode tabs 102 may be aligned and overlapping with each other). The stacked first electrode tabs 102 may be attached to each other by forming an adhesive portion AP (as shown in FIG. 12) by laser welding or ultrasonic welding. Because the first electrode tab 102 is formed by the conductive tape 140 surrounding the substrate, the stacked first electrode tabs 102 may be electrically connected by attaching the stacked conductive tapes 140 to each other by laser welding or ultrasonic welding. In some embodiments, the second electrode tabs 202 formed on the second electrode 200 may also be electrically connected to each other by laser welding or ultrasonic welding.

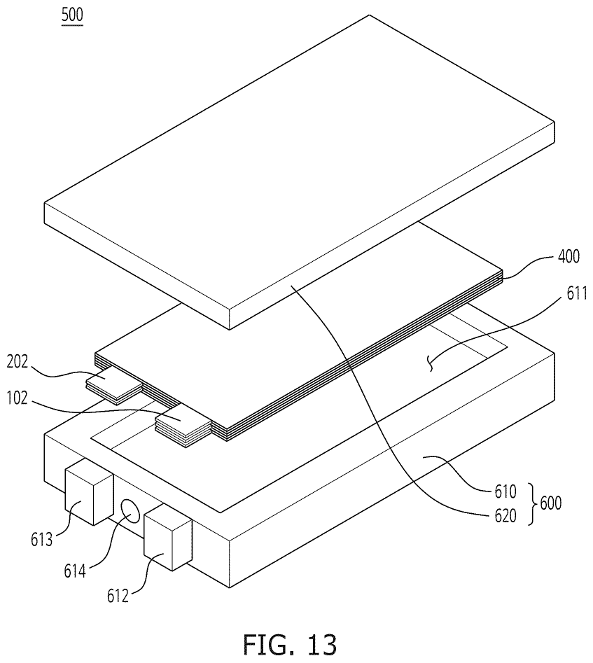

FIG. 13 illustrates an exploded perspective view showing an example of a secondary battery according to some embodiments of the present disclosure.

Referring to FIG. 13, a secondary battery 500 according to some embodiments of the present disclosure may include an electrode assembly 400 and a case 600 that accommodates the electrode assembly 400. The electrode assembly 400 may include a first electrode, a separator, and a second electrode.

The case 600 may form the overall appearance of the secondary battery. According to some embodiments, the case 600 may be formed of stainless steel (SUS). In some embodiments, the case 600 may be made of (or include) a conductive metal, such as aluminum, an aluminum alloy, or nickel-plated steel. In some embodiments, the case 600 may provide a space in which the electrode assembly 400 is accommodated.

The case 600 according to some embodiments may include a case body 610 having one opened side and having an electrode assembly accommodation groove 611 formed so that the electrode assembly 400 is accommodated therein, and a case cover 620 that is configured to be joined to the opened side of the case body 610 to seal the opened side of the case body 610 and thus seal the electrode assembly 400 in the electrode assembly accommodation groove 611.

The case body 610 and the case cover 620 may be joined by welding. In some embodiments, a flange area may be formed at the edge of the case body 610, a portion where the flange area and the case cover 620 come into contact with each other may be sealed by welding or the like, and then the flange area may be removed to join the case body 610 to the case cover 620.

The case 600 may include a first electrode terminal 612 on one side, a second electrode terminal 613 spaced apart from the first electrode terminal 612 by a certain interval, and a through-hole 614. The first electrode terminal 612 and the second electrode terminal 613 may be electrically connected in contact with a first electrode tab 102 and a second electrode tab 102, respectively, of the electrode assembly 400. The through-hole 614 may be configured to serve as a passage for smooth impregnation or injection of an electrolyte into the case 600. The through-hole 614 may be formed between the first electrode terminal 612 and the second electrode terminal 613, but the present disclosure is not limited thereto.

The electrode assembly 400 may be formed by alternately stacking a plurality of first electrodes, separators, and second electrodes having a thin plate shape or a film shape. In some embodiments, the electrode assembly 400 may have substantially the same configuration as the electrode assembly 400 described with reference to FIG. 12.

The secondary battery 500 according to some embodiments of the present disclosure has been described focusing on a prismatic battery, but the present disclosure is not limited thereto, and the present disclosure may also be applied to other types of batteries having a pouch-type battery, etc.

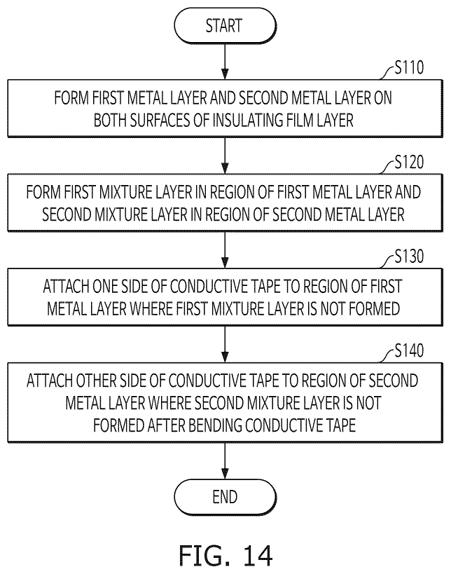

FIG. 14 illustrates a flowchart showing aspects of a method for manufacturing an electrode according to some embodiments of the present disclosure.

Referring to FIG. 14, a method for manufacturing an electrode according to some embodiments of the present disclosure may include forming a first metal layer and a second metal layer on opposite surfaces of an insulating film layer (S110), forming a first mixture layer in a region of the first metal layer and a second mixture layer in a region of the second metal layer (S120), attaching one side of a conductive tape to a region of the first metal layer where the first mixture layer is not formed (S130), and attaching the other side of the conductive tape to a region of the second metal layer where the second mixture layer is not formed after bending the conductive tape (S140). In the attaching of the conductive tape, the conductive tape may be attached at an interval of approximately 1 mm to approximately 2 mm from the first mixture layer and the second mixture layer.

In some embodiments, the method may further include applying a conductive paste and a binder between the conductive tape and at least one of the first metal layer and the second metal layer before the attaching of the conductive tape. The order and positions in which the conductive paste and the binder are applied may be substantially the same as the order and positions in which the conductive paste and the binder are applied as described above with reference to FIGS. 6 to 8.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Description of Symbols

| | |
|---|---|
| 100: electrode, first electrode | 102: first electrode tab |
| 110: insulating film layer | 121: first metal layer |
| 122: second metal layer | 131: first mixture layer |
| 132: second mixture layer | 140: conductive tape |
| 151: conductive paste | 152: binder |
| 200: second electrode | 202: second electrode tab |
| 300: separator | 400: electrode assembly |

What is claimed is:

1. An electrode comprising:
an insulating film layer comprising an insulating material;
a first metal layer on one surface of the insulating film layer;
a second metal layer on another surface of the insulating film layer;
a first mixture layer on the first metal layer;
a second mixture layer on the second metal layer; and
a conductive tape attached to the first metal layer and the second metal layer and configured to electrically connect the first metal layer to the second metal layer.

2. The electrode as claimed in claim 1, wherein the conductive tape comprises:
a first attachment portion attached to the first metal layer;
a second attachment portion attached to the second metal layer; and
a bent portion bent between the first attachment portion and the second attachment portion.

3. The electrode as claimed in claim 2, wherein the bent portion is attached to ends of the first metal layer, the insulating film layer, and the second metal layer.

4. The electrode as claimed in claim 2, wherein the bent portion is spaced apart from ends of the first metal layer, the insulating film layer, and the second metal layer.

5. The electrode as claimed in claim 1, wherein the conductive tape comprises a same material as a material of at least one of the first metal layer or the second metal layer.

6. The electrode as claimed in claim 1, wherein the conductive tape comprises at least one of aluminum, an aluminum alloy, copper, a copper alloy, nickel, or a nickel alloy.

7. The electrode as claimed in claim 1, wherein a thickness of the conductive tape is in a range from approximately 1 μm to approximately 6 μm.

8. The electrode as claimed in claim 1, further comprising a conductive paste and a binder between the conductive tape and at least one of the first metal layer or the second metal layer.

9. The electrode as claimed in claim 8, wherein the conductive paste is on at least one of the first metal layer or the second metal layer, and
wherein the binder is on one surface of the conductive tape.

10. The electrode as claimed in claim 8, wherein the conductive paste is on one surface of the conductive tape, and wherein the binder is on the conductive paste.

11. The electrode as claimed in claim 8, wherein the conductive paste is on one surface of the conductive tape,
wherein the binder is on the conductive paste, and
wherein the conductive paste is on at least one of the first metal layer or the second metal layer.

12. The electrode as claimed in claim 8, wherein the conductive paste is a same material as a material of the conductive tape.

13. The electrode as claimed in claim 8, wherein the conductive paste comprises a same material as a material of at least one of the first metal layer or the second metal layer.

14. The electrode as claimed in claim 1, wherein the conductive tape comprises:
a first conductive tape attached to the first metal layer; and
a second conductive tape attached to the second metal layer and to the first conductive tape.

15. The electrode as claimed in claim 14, wherein one end of the first conductive tape is attached to the first metal layer,
wherein one end of the second conductive tape is attached to the second metal layer, and
wherein another end of the first conductive tape and another end of the second conductive tape are attached to each other.

16. The electrode as claimed in claim 14, further comprising a conductive paste and a binder between the first metal layer and the first conductive tape and between the second metal layer and the first conductive tape.

17. The electrode as claimed in claim 16, wherein the conductive paste and the binder are on one surface of the first conductive tape and one surface of the second conductive tape.

18. An electrode assembly comprising:
a first electrode comprising at least a first electrode tab;
a second electrode comprising at least a second electrode tab; and
a separator between the first electrode and the second electrode,
wherein at least one of the first electrode or the second electrode comprises:
an insulating film layer comprising an insulating material;
a first metal layer on one surface of the insulating film layer;
a second metal layer on another surface of the insulating film layer;
a first mixture layer on the first metal layer;
a second mixture layer on the second metal layer; and
a conductive tape attached to the first metal layer and the second metal layer and electrically connecting the first metal layer to the second metal layer.

19. The electrode assembly as claimed in claim 18, wherein both of the first electrode and the second electrode comprises the conductive tape.

20. The electrode assembly as claimed in claim 19, wherein the first electrode tab comprises a plurality of stacked first electrode tabs,
wherein the second electrode tab comprises a plurality of stacked second electrode tabs, and
wherein at least one of the plurality of stacked first electrode tabs or the plurality of stacked second electrode tabs comprises a plurality of stacked conductive tapes attached and connected to each other.
